(19) United States
(12) Patent Application Publication
(10) Pub. No.: US 2026/0025322 A1
(43) Pub. Date: Jan. 22, 2026

(54) DEEP LEARNING INFERENCE OPTIMIZATION AND BENCHMARKING FOR GATEWAY SYSTEMS

(71) Applicant: Schlumberger Technology Corporation, Sugar Land, TX (US)

(72) Inventors: Hui Wang, Menlo Park, CA (US); Chen Lin, Beijing (CN); Salma Benslimane, Menlo Park, CA (US)

(21) Appl. No.: 19/276,993

(22) Filed: Jul. 22, 2025

Related U.S. Application Data
(60) Provisional application No. 63/673,863, filed on Jul. 22, 2024.

(51) Int. Cl. H04L 43/065; G06F 11/34; H04L 41/16

(52) U.S. Cl. CPC H04L 43/065; G06F 11/3428; H04L 41/16

(57) ABSTRACT

This disclosure is directed to a benchmarking method comprising: receiving data from a plurality of sources; provisioning a computing model configured to characterize features or properties associated with a resource site, the computing model being adaptable or configurable to be used on one of a first edge computing device or a cloud computing device; determining a first computational tool associated with the first edge computing device; quantizing, using the first computational tool, the computing model and thereby generate a first quantized model with attendant benchmark data indicating an efficacy of the computing model on the first edge computing device when the computing model is successfully deployed via a gateway system coupling the plurality of sources to the first edge computing device; and generating a report indicating performance data of the computing model on the first edge computing device after deployment to the first edge computing device.

### CROSS-REFERENCE TO RELATED APPLICATIONS

This application claims priority to and benefit of U.S. Provisional Patent App. No. 63/673,863, filed on Jul. 22, 2024, and titled “Deep Learning Inference Optimization and Benchmarking For Gateway Systems,” which is incorporated herein by reference in its entirety for all purposes.

### BACKGROUND

As more and more machine learning (ML) models are deployed to edge computing devices, and more and more hardware is being built for said ML models, there is a need to develop mechanisms that transform (i.e., optimize, configure, or tune) ML models to optimally operate on said edge computing devices thereby bridging the gap between ML models and hardware specifications of edge computing devices.

Furthermore, there is a need to understand how to choose the right optimization technique that delivers a given ML model to specific computing hardware. In addition, it is needful to optimally diagnose performance issues that facilitate or otherwise enable speeding up or improving the performance of deployed ML models on similar or dissimilar computing systems (e.g., edge computing systems) with varying computer hardware.

### SUMMARY

This disclosure is directed to benchmarking methods, systems, and computer programs for enabling communication between data sources and an edge computing device via a gateway system. According to an embodiment, a benchmarking method for enabling communication between data sources and an edge computing device via a gateway system comprises: receiving data from a plurality of sources, the plurality of data sources comprising data associated with a resource site; and provisioning a computing model configured to characterize one or more features or properties associated with the resource site, the computing model being adaptable or configurable to be used on one of a first edge computing device or a cloud computing device.

The method further comprises determining a first computational tool associated with the first edge computing device, the first computational tool being operable to: automatically extract device data associated with the first edge computing device; and quantize the computing model to optimally perform on the first edge computing device.

According to one embodiment, the method comprises: quantizing, using the first computational tool, the computing model and thereby generate a first quantized model with attendant benchmark data, the attendant benchmark data indicating an efficacy of the computing model on the first edge computing device when the computing model is successfully deployed via the gateway system coupling the plurality of sources to the first edge computing device; and generating a report indicating image or textual information associated with how the computing model performs on the first edge computing device after deployment to the first edge computing device, the report being visualized on a graphical display device.

In other embodiments, a system and a computer program can include or execute the method described above. These and other implementations may each optionally include one or more of the following features.

The computing model is a computer vision model according to some embodiments.

The device data can comprise one or more of: hardware data of the first edge computing device; software data of the first edge computing device; or firmware data of the first edge computing device.

Furthermore, the hardware data can comprise one of: graphical display unit data associated with the first edge computing device; or central processing unit data associated with the first edge computing device.

According to one embodiment, quantizing the computing model comprises stripping or trimming parameters of the computing model that contribute to model inefficiencies of the computing model on the first edge computing device.

In some cases, quantizing the computing model comprises optimizing the computing model to be compatible with one or more hardware accelerators of the first edge computing device.

Furthermore, quantizing the computing model can comprise: determining a computation float point for the computing model based on the extracted device data; and automatically configuring the computing model to quickly execute computing operations associated with the resource site on the first edge computing device.

In one embodiment, the first computational tool comprises one of an application programming interface (API) or a compiler.

In other embodiments, the first computational tool comprises a computing platform configured for developing deep learning models.

In some cases, the computing model comprises a machine learning model or an artificial intelligence model.

In addition, the gateway system comprises an Agora gateway system according to some embodiments.

Moreover, the gateway system may be configured or coupled to sensor systems associated with collecting data at the resource site.

It is appreciated that the resource site comprises a resource site associated with energy development.

It is further appreciated that the attendant benchmark data indicates baseline performance data associated with implementing the computing model on the cloud computing device.

According to one embodiment, the disclosed method further comprises: determining a second computational tool associated with a second edge computing device; quantizing, using the second computational tool, the computing model and thereby generate a second quantized model; and deploying the second quantized model via the gateway system to the second edge computing device. The second edge computing device may be operable to rapidly execute a plurality of computing operations associated with the resource site using the second quantized model.

In some cases, the first edge computing device and the second edge computing device are distinct from each other based on at least one of: first hardware of the first edge computing device being different from second hardware of the second edge computing device; first firmware of the first edge computing device being different from second firmware of the second edge computing device; or first software of the first edge computing device being different from second software of the second edge computing device.

### BRIEF DESCRIPTION OF THE DRAWINGS

This disclosure is illustrated by way of example, and not by way of limitation in the figures of the accompanying drawings in which like reference numerals are used to refer to similar elements. It is appreciated that various features may not be drawn to scale and the dimensions of various features may be arbitrarily increased or reduced for clarity of discussion.

FIG. 1 shows an exemplary interconnection between data sources and edge computing devices via a gateway system, according to an embodiment.

FIG. 2 shows a cross-sectional view of a resource site for which the process of FIG. 1 may be executed, according to an embodiment.

FIG. 3 shows a network system illustrating a communicative coupling of devices or systems associated with the resource site of FIG. 2, according to an embodiment.

FIG. 4A shows an exemplary electronic dashboard associated with an ontology dataset, according to some embodiments.

FIG. 4B shows a second exemplary ML model development and deployment life-cycle, according to some embodiments.

FIG. 5 shows an exemplary workflow representing the implementation indicated in FIG. 4B.

FIG. 6 shows an exemplary workflow for deploying an ML model to similar or dissimilar edge computing devices.

FIG. 7 shows an interaction between computing services and gateway systems during model deployment and benchmarking.

FIG. 8 shows an exemplary benchmarking workflow for enabling communication between data sources and an edge computing device via a gateway system.

### DETAILED DESCRIPTION

Reference will now be made in detail to embodiments, examples of which are illustrated in the accompanying drawings and figures. In the following detailed description, numerous specific details are set forth in order to provide a thorough understanding of the disclosed subject-matter. However, it will be apparent to one of ordinary skill in the art that this disclosure may be practiced without these specific details. In other instances, well-known methods, procedures, components, circuits, and networks have not been described in detail so as not to unnecessarily obscure aspects of the embodiments.

The disclosed systems and methods may be accomplished using interconnected devices and systems that obtain a plurality of data associated with various parameters of interest at a resource site. The workflows/flowcharts described in this disclosure, according to some embodiments, implicate a new processing approach (e.g., hardware, special purpose processors, and specially programmed general-purpose processors) because such analyses are too complex and cannot be done by a person in the time available or at all. Thus, the described systems and methods are directed to tangible implementations or solutions to specific technological problems in exploring/developing energy resources and/or exploring natural resources such as oil, gas, water, and other mineral resources.

Attention is now directed to methods, techniques, infrastructure, and workflows for operations provided in this disclosure. Some operations in the processing procedures, methods, techniques, and workflows disclosed herein may be combined while the order of some operations may be changed. Some embodiments include an iterative refinement of one or more data associated with the resource site or energy development operations via feedback loops executed by one or more computing device processors and/or through other control devices/mechanisms that make determinations regarding whether a given action, template, transformer model, or other resource data, is sufficiently accurate.

### Network Sub-System

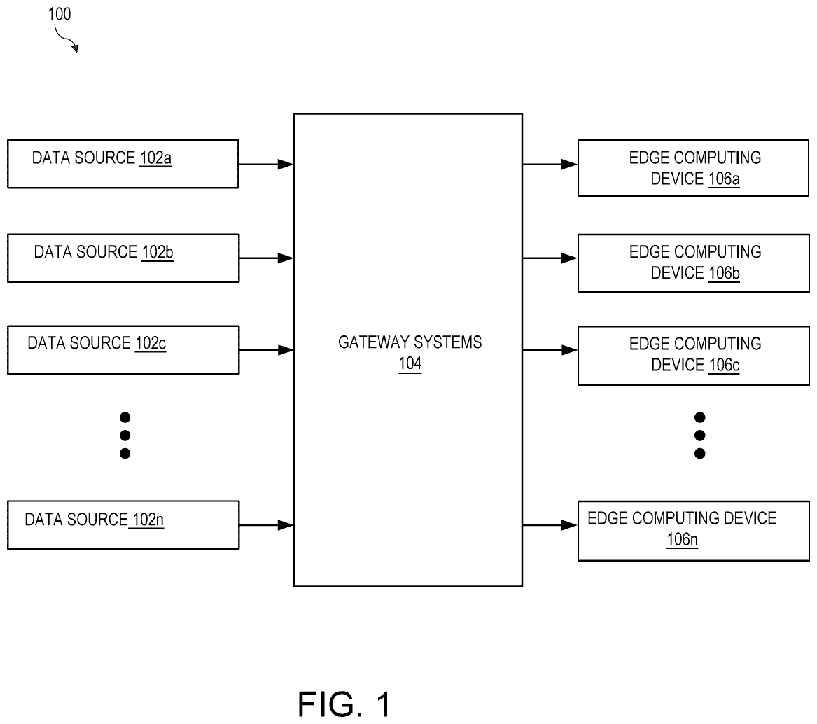

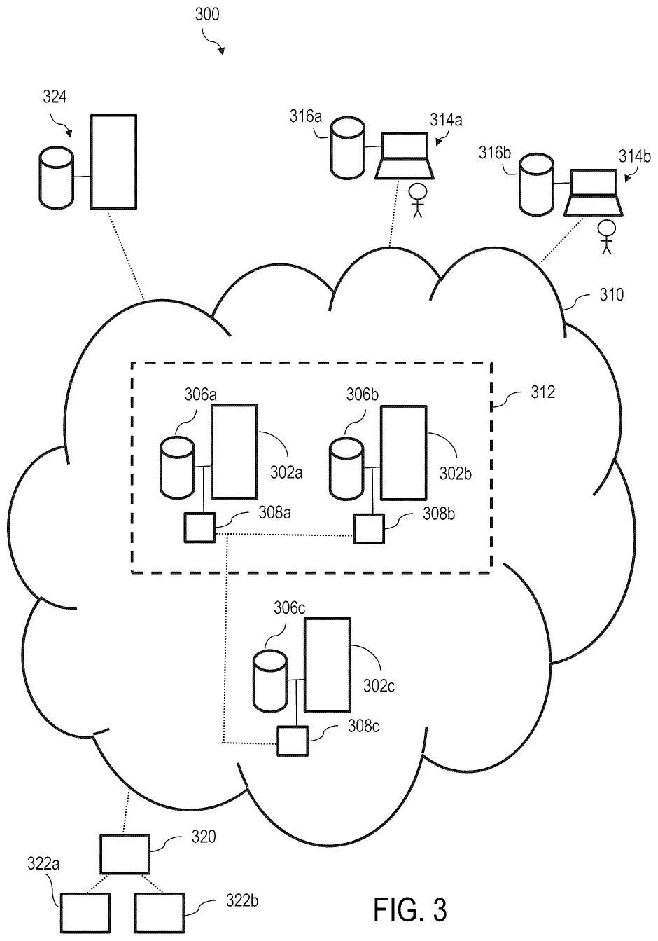

FIG. 1 shows an exemplary interconnection 100 between data sources and edge computing devices via a gateway system. According to one embodiment, the interconnection 100 depicted in this figure form a subsystem of the network system 300 of FIG. 3 and can include a plurality of data sources 102a . . . 102n communicatively or electrically coupled to edge computing devices 106a . . . 106n via one or more gateway systems 104.

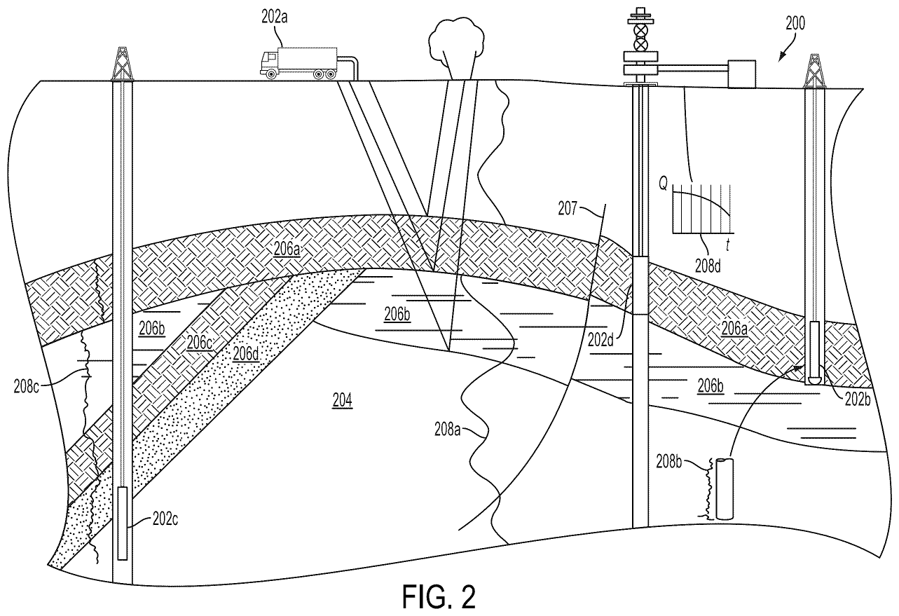

According to one embodiment, the plurality of data sources 102 . . . 102n may comprise data sources including sensors that capture surface and/or subsurface data associated with a resource site, computing systems associated with a resource site, and/or other energy development systems at, or associated with the resource site. These aspects are further discussed in association with FIG. 2.

The one or more gateway systems 104 may comprise one or more computing systems that are coupled to similar or dissimilar computing networks or applications associated with the resource site. In particular, the one or more gateway systems 104 can convert information, data, or other communications from one data protocol or data format to another data protocol or data format and thereby facilitate data communication between: different applications (e.g., two or more applications) associated with the resource site; and/or different systems (e.g., two or more systems) associated with the resource site; and/or different applications (e.g., two or more applications) and systems (e.g., two or more systems) associated with the resource site. In some cases, the one or more gateway systems can comprise an Agora server gateway system (also called Agora gateway systems elsewhere herein) deployed to transmit audio data streams and/or video data streams to applications and/or systems associated with the resource site. It is appreciated that the one or more gateways systems 104 can beneficially enable communication between one or more servers associate with the resource site and applications associated with an Agora global network comprising one or more Agora gateway systems. It is appreciated that the gateway systems 104 can operate as an interface between the plurality of data sources 102a . . . 102n and the edge computing devices 106a . . . 106n.

Turning back to FIG. 1, the edge computing devices 106a . . . 106n can comprise one or more of laptops, desktops, mobile computing devices, tablet computing devices, electronic wrist watch computing devices, etc. According to one embodiment, the edge computing devices 106a . . . 106n may be configured for non-cloud computing operations which advantageously leverage model quantization computing operations to facilitate model deployment and usage for energy modeling computing operations. In particular, because some edge computing devices 106a . . . 106n lack the processing power and/or have hardware limitations, software limitations, or firmware limitations associated with, independent of, or relative to cloud computing systems, the disclosed methods and systems resolve such limitations via quantizing and/or appropriately configuring computing models associated with energy development for optimal usage on the edge computing devices 106a . . . 106n which may or may not rely on cloud computing.

### Data Sources

FIG. 2 shows a cross-sectional view of a resource site 200 for which the process of FIG. 1 may be executed. While the illustrated resource site 200 represents an exemplary subterranean formation for which actual data (e.g., data from sensors) may be received to generate one or more computing models, resource site 200 may be modeled, according to some embodiments, using synthetic data or historical data associated with sites that are similar or dissimilar relative to the resource site 200. It is appreciated that the illustrated resource site 200 may be below water bodies such as oceans, seas, lakes, ponds, wetlands, and rivers.

According to one embodiment, various measurement tools capable of sensing one or more parameters such as seismic two-way travel time, density, resistivity, and fluid production rate of a subterranean formation and/or a geological formation may be provided at the resource site. As an example, wireline tools may be used to obtain measurement information related to geological attributes (e.g., geological attributes of a wellbore and/or reservoir) including geophysical and/or geochemical information associated with the resource site 200. In some embodiments, various sensors may be located at various locations around the resource site 200 to monitor and/or collect data for executing the process of FIG. 1.

As previously noted, part, or all, of the resource site 200 may be on land, on water, or below water. In addition, while a single resource site 200 is depicted in FIG. 2, the technology described herein may be used with any combination of multiple resource sites (e.g., multiple oil fields and/or multiple wellsites), and/or one or more processing facilities associated with processing energy-based raw materials (e.g., hydrocarbons, coal, Salar brines, etc.).

As can be seen in FIG. 2, the resource site 200 may have data acquisition tools 202a, 202b, 202c, and 202d positioned at various locations within the resource site 200. The subterranean structure 204 may have a plurality of geological formations 206a-206d. As shown, this structure may have several formations or layers, including a shale layer 206a, a carbonate layer 206b, a shale layer 206c, and a sand layer 206d. A fault 207 may extend through the shale layer 206a and the carbonate layer 206b. The data acquisition tools, for example, may be adapted or otherwise configured to take data measurements and/or detect geophysical and/or geochemical characteristics of the various formations shown.

While a specific subterranean formation with specific geological structures/properties is depicted, it is appreciated that the resource site 200 may contain a variety of geological structures and/or formations, sometimes having extreme complexity. In some locations of a given geological structure, for example below a water line relative to the given geological structure, fluid may occupy pore spaces of the formations. Each of the measurement devices (e.g., sensors) may be used to measure properties of the formations and/or other geological features. While each data acquisition tool is shown as being in specific locations in FIG. 2, it is appreciated that one or more types of measurements may be taken at one or more locations (e.g., locations with sensors that serve as the data sources referenced in conjunction with FIG. 1) of the resource site 200 or other locations (e.g., locations similar or dissimilar to the one or more locations of the resource site 200) that are distal or proximal relative to the resource site 200 for comparison and/or additional analysis. In addition, data (e.g., data acquired using one or more sensors deployed about the resource site 200) may be acquired and remotely transmitted for processing or analysis. The data collected from various sources (e.g., data collected using one or more sensors deployed about the resource site 200) at the resource site 200 may be processed and/or evaluated and/or used as training data, and or used to generate high resolution result sets for characterizing a resource at the resource site 200, and/or used for generating resource models.

In one embodiment, the data collected by one or more sensors deployed about the resource site 200 may include: data associated with the number of wells of a first reservoir or second reservoir at the resource site 200; data associated with the number of grid cells of the first or second reservoir at the resource site 200; data associated with the average permeability of the first or second reservoir at the resource site 200; data associated with fluid production history (e.g., quantitative or qualitative data indicating the number of years of fluid production, types of fluid(s) produced, or the amount of fluids produced, etc.) of the first reservoir and/or the second reservoir at the resource site 200; etc. According to some embodiments, the number of wells of the first or second reservoir at the resource site 200 may include one or more injectors (e.g., one or more wells into which fluid including water can be pumped) and/or one or more producers (e.g., one or more wells from which fluid including hydrocarbons can be extracted).

Data acquisition tool 202a is illustrated as a measurement truck, which may comprise devices or sensors that take measurements (e.g., raw data) of the subsurface through sound vibrations such as, but not limited to, seismic measurements. Drilling tool 202b may include a downhole sensor adapted to perform logging while drilling (LWD) data collection. Wireline tool 202c may include a downhole sensor deployed in a wellbore or borehole. Production tool 202d may be deployed from a production unit or Christmas tree into a completed wellbore. Examples of parameters that may be measured using the data acquisition tool 202a, the drilling 202b, or the wireline tool 202c can include weight on bit data, torque on bit data, subterranean pressure (e.g., underground fluid pressure) data, temperature data, flow rate data, fluid composition data, rotary speed data, particle count data, voltage data, current data, gamma ray data associated with a well at the resource site, resistivity data associated with a well at the resource site, density data, porosity data associated with a well at the resource site, water saturation data associated with a well at the resource site, hydrocarbon saturation data associated with a well at the resource site, and/or other parameters associated with operations at the resource site.

In one embodiment, sensors may be positioned about the resource site 200 to collect data (e.g., raw data) relating to various oil field operations, such as sensors deployed by the data acquisition tools 202. The sensors may include any type of sensor such as a metrology sensor (e.g., temperature sensor, humidity sensor, pressure sensor, etc.), an automation enabling sensor, an operational sensor (e.g., pressure sensor, H₂S sensor, thermometer, depth sensor, tension sensor), evaluation sensors, etc., that can be used for acquiring data regarding a geological formation at the resource site 200, wellbore information, formation fluid/gas information, wellbore fluid information, and data associated with gas/oil/water comprised in the formation/wellbore fluid. For example, the sensors may include accelerometers, flow rate sensors, pressure transducers, electromagnetic sensors, acoustic sensors, temperature sensors, chemical agent detection sensors, nuclear sensor, and/or any additional suitable sensors. In one embodiment, the data captured by the one or more sensors may be used to characterize, or generate one or more parameter values for a high-resolution result set used to, for example, generate and/or configure a resource model and/or a transformer model and/or a forecasting model. In some embodiments, test data or synthetic data may also be used in developing and/or configuring the resource model and/or the transformer model and/or the forecasting model via one or more simulations and/or testing operations.

Evaluation sensors may be featured in downhole tools such as tools 202b-202d and may include for instance electromagnetic, acoustic, nuclear, and optic sensors. Examples of tools including evaluation sensors that can be used in the framework of the current methods and systems include electromagnetic tools such as: imaging sensors including FMI™ or QuantaGeo™ (mark of SLB, Houston, TX); induction sensors such as Rt Scanner™ (mark of SLB, Houston, TX); multifrequency dielectric dispersion sensors such as Dielectric Scanner™ (mark of SLB, Houston, TX); acoustic tools including sonic sensors such as Sonic Scanner™ (mark of SLB, Houston, TX); ultrasonic sensors such as pulse-echo sensor as in UBI™ or PowerEcho™ (marks of SLB, Houston, TX); flexural sensors PowerFlex™ (mark of SLB, Houston, TX); nuclear sensors such as Litho Scanner™ (mark of SLB, Houston, TX); nuclear magnetic resonance sensors; fluid sampling tools including fluid analysis sensors such as InSitu Fluid Analyzer™ (mark of SLB, Houston, TX); distributed sensors including fiber optic; etc. Such evaluation sensors may be used, in particular, for evaluating (e.g., determining petrophysical or geological properties of the formation) the formation in which a well is formed, thereby verifying the integrity of the well (e.g., generating casing or cement properties of the well to assess well integrity) and/or analyzing produced fluid (e.g., flow rate data and type of fluid data).

As shown, data acquisition tools 202a-202d may generate data plots or measurements 208a-208d, respectively. These data plots are depicted within the resource site 200 to demonstrate that data generated by some of the operations executed at the resource site 200.

Data plots 208a-208c are examples of static data plots that may be generated by data acquisition tools 202a-202c, respectively. However, it is herein contemplated that data plots 208a-208c may also be data plots that may be generated and updated in real time. These measurements may be analyzed to better define properties of the formation(s) and/or determine the accuracy of the measurements and/or check for and compensate for measurement errors. The plots of each of the respective measurements may be aligned and/or scaled for comparison and verification purposes. In some embodiments, base data (e.g., raw data) associated with the plots may be incorporated into site planning, modeling a test at the resource site 200 to generate, for example, information data and/or knowledge data. The respective measurements that can be taken may be any of the above. It is appreciated that the plots 201a . . . 208c can be generated and/or stored digitally and may be replicated or otherwise printed to multiple file formats and/or printed on paper as the case may require.

Other data may also be collected, such as historical data of the resource site 200 and/or sites similar to the resource site 200, user inputs, information (e.g., economic information) associated with the resource site 200 and/or sites similar to the resource site 200, and/or other measurement data or other parameters of interest. Similar measurements may also be used to measure or otherwise track changes in subsurface formation structures over time.

Computer facilities such as those discussed in association with FIG. 3 may be positioned at various locations about the resource site 200 (e.g., a surface unit) and/or at other remote locations relative to the resource site 200. A surface unit (e.g., one or more terminals 320) may be used to communicate with onsite tools and/or offsite operations, as well as with other surface or downhole sensors associated with the resource site. The surface unit may be capable of sending commands to the oil field equipment/systems, and receiving data therefrom. The surface unit may also collect data generated during production operations and can produce output data, which may be stored or transmitted for further processing.

The data collected by sensors associated with the resource site 200 may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis or for modeling purposes to optimize production processes at the resource site 200. In one embodiment, the data is stored in separate databases, or combined into a single database. It is appreciated that the term optimize/optimal and its variants (e.g., efficient or optimally) may simply indicate improving, rather than the ultimate form of ‘perfection’ or the like.

### Network System

FIG. 3 shows a high-level network system 300 illustrating a communicative coupling of devices or systems associated with the resource site 200 of FIG. 2. The system shown in the figure may include a set of processors 302a, 302b, and 302c for executing one or more processes discussed herein. The set of processors 302 may be electrically coupled to one or more servers (e.g., computing systems) including memory 306a, 306b, and 306c that may store for example, program data, databases, and other forms of data. Each server of the one or more servers may also include one or more communication devices 308a, 308b, and 308c. The set of servers may provide a cloud-computing platform 310. In one embodiment, the set of servers includes different computing devices that are situated in different locations and may be scalable based on the needs and workflows associated with the resource site 200 of FIG. 2. The communication devices of each server may enable the servers to communicate with each other through a local or global network such as an Internet network. In some embodiments, the servers may be arranged as a town 312, which may provide a private or local cloud service for users. A town may be advantageous in remote locations with poor connectivity. Additionally, a town may be beneficial in scenarios with large networks where security may be of concern. A town in such large network embodiments can facilitate implementation of a private network within such large networks. The town may interface with other towns or a larger cloud network, which may also communicate over public communication links. Note that cloud-computing platform 310 may include a private network and/or portions of public networks. In some cases, a cloud-computing platform 310 may include remote storage and/or other application processing capabilities.

The system of FIG. 3 may also include one or more user terminals 314a and 314b each including at least a processor to execute programs, a memory (e.g., 316a and 316b) for storing data, a communication device and one or more user interfaces and devices that enable the user to receive, view, and transmit information. In one embodiment, the user terminals 314a and 314b is a computing system having interfaces and devices including keyboards, touchscreens, display screens, speakers, microphones, a mouse, and/or styluses. The user terminals 314 may be coupled to the one or more servers of the cloud-computing platform 310. The user terminals 314 may be client terminals or expert terminals, enabling collaboration between clients and experts through the system of FIG. 3.

The system of FIG. 3 may be associated with at least one or more resource sites 200 of FIG. 2 having, for example, a set of terminals 320, each including at least a processor, a memory, and a communication device for communicating with other devices coupled to the cloud-computing platform 310. The resource site 200 of FIG. 2 may also have one or more sensors (e.g., one or more sensors described in association with FIG. 2) or sensor interfaces 322a and 322b coupled to the set of terminals 320 and/or directly coupled to the cloud-computing platform 310. In some embodiments, data collected by the one or more sensors/sensor interfaces 322a and 322b may be processed to generate a one or more resource models (e.g., reservoir models) and/or one or more forecasting models and/or one or more resolved datasets used to generate the resource model and/or forecasting model which may be displayed on a user interface associated with the set of terminals 320, and/or displayed on user interfaces associated with the set of servers of the cloud computing platform 310, and/or displayed on user interfaces of the user terminals 314. Furthermore, various equipment/devices discussed in association with the resource site 200 of FIG. 2 may also be coupled to the set of terminals 320 and/or coupled directly to the cloud-computing platform 310. The equipment and sensors may also include one or more communication device(s) that may communicate with the set of terminals 320 to receive orders/instructions locally and/or remotely from the resource site 200 of FIG. 2 and also send statuses/updates to other terminals such as the user terminals 314.

The system of FIG. 3 may also include one or more client servers 324 including a processor, memory, and communication device. For communication purposes, the client servers 324 may be coupled to the cloud-computing platform 310, and/or to the user terminals 314a and 314b, and/or to the set of terminals 320 at the resource site 200 of FIG. 2 and/or to sensors at the oil field, and/or to other equipment at the resource site 200 of FIG. 2.

A processor, as discussed with reference to the system of FIG. 3, may include a microprocessor, a graphical processing unit (GPU), a microcontroller, a processor module or subsystem, a programmable integrated circuit, a programmable gate array, or another control or computing device. According to some implementations, the system of FIG. 3 may comprise a cloud or a non-cloud virtual computing system that can implement one or more processes provided in this disclosure.

The memory/storage media discussed above in association with FIG. 3 can be implemented as one or more computer-readable or machine-readable storage media that are non-transitory. In some embodiments, storage media may be distributed within and/or across multiple internal and/or external enclosures of a computing system and/or additional computing systems. Storage media may include one or more different forms of memory including: semiconductor memory devices such as dynamic or static random access memories (DRAMs or SRAMs); erasable and programmable read-only memories (EPROMs); electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. “Non-transitory” computer readable medium refers to the medium itself (e.g., tangible medium, not a signal) and not data storage persistency (e.g., RAM vs. ROM).

Note that instructions can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). The storage medium or media can be located either in a computer system running the machine-readable instructions, or located at a remote site from which machine-readable instructions can be downloaded over a network for execution. In some implementations, the instructions can be remotely executed or otherwise downloaded by a computing device (e.g., a client system) coupled to a cloud system (e.g., a cloud server) configured to execute the processes outlined in this disclosure.

It is appreciated that the described system of FIG. 3 is an example that may have more or fewer components than shown, may combine additional components, and/or may have a different configuration or arrangement of the components. The various components shown may be implemented in hardware, software, or a combination of both hardware and software, including one or more data processing engines or a data manager module and/or application specific integrated circuits.

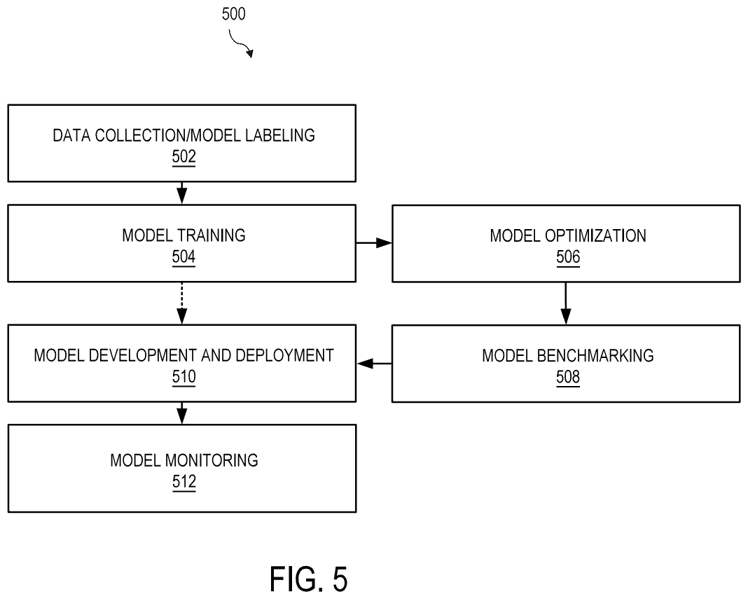

Further, the steps in the flowchart described below may be implemented by running one or more functional modules in an information processing apparatus such as general-purpose processors or application specific chips, such as ASICs, FPGAS, PLDs, GPUs or other appropriate devices associated with the system of FIG. 3. For example, the workflows of FIGS. 5, 6, and 8 may be executed using a data processing engine stored in memory 306a, 306b, or 306c such that the data processing engine includes instructions that are executed by the one or more processors such as processors 302a, 302b, or 302c as the case may be. The various modules of FIG. 3, combinations of these modules, and/or their combination with general hardware are included within the scope of protection of the disclosure.

While one or more computing processors (e.g., processors 302a, 302b, or 302c) may be described as executing steps associated with one or more of the workflows described in this disclosure, the one or more computing device processors may be associated with the cloud-based computing platform 310 and may be located at one location or distributed across multiple locations. In one embodiment, the one or more computing device processors may also be associated with other systems of FIG. 3 other than the cloud-computing platform 310.

In some embodiments, a computing system is provided that includes at least one processor, at least one memory, and one or more programs stored in the at least one memory, such that the one or more programs comprise instructions, which when executed by the at least one processor, are configured to perform any method or workflow disclosed herein.

In some embodiments, a computer readable storage medium is provided, which has stored therein one or more programs, the one or more programs including instructions, which when executed by a processor, cause the processor to perform any method or workflow disclosed herein. In some embodiments, a computing system is provided that includes at least one processor, at least one memory, and one or more programs stored in the at least one memory for performing any method or workflow disclosed herein. In some embodiments, an information processing apparatus for use in a computing system is provided for performing any method disclosed herein.

### Embodiments

The disclosed technology is directed to creating an automated pipeline or workflow that optimizes and/or benchmarks performance data of ML models (e.g., computer vision computing models or a computer vision deep-learning inference models) on gateway computing systems (e.g., Agora gateway computing systems). According to one embodiment, the ML models disclosed can be associated with multiple layers or tiers of the gateway computing systems. For example, the multiple layers or tiers of the gateway computing systems can comprise a plurality of application layers and/or a plurality of hardware layers. It is appreciated that the gateway systems can serve as intermediary systems between a plurality of data sources including sensors from a resource site or some other field of interest and one or more edge computing systems as indicated in FIG. 1.

According to some embodiments, the disclosed methods and systems explore speed and/or accuracy and/or memory trade-off data associated with intelligent learning structures (e.g., deep neural network) of the disclosed ML models to provide a guideline for selecting appropriate models for the gateway computing systems and thereby achieve optimal performance for said ML models.

According to one embodiment, the disclosed pipeline or workflow can comprise two aspects: a model optimization aspect; and a model inference benchmarking aspect. The model optimization aspect can be associated with testing one or more ML model compilation techniques (e.g., different ML model compilation techniques) to convert or otherwise transform a given ML model to a format that accommodates or is compatible with the gateway computing system's architecture with different degrees of precision.

It is appreciated that when running an ML model on an edge computing device, the ML model's success or model convergence (e.g., scenarios where the ML model's parameters reach a stable, predictable state after training) can depend on the type of hardware of the edge computing device. This makes it needful to understand how to compile and/or optimize model performance (e.g., performance data associated with an ML model in question) of the ML model to run efficiently on different hardware (e.g., hardware accelerators) that impact the ML models performance. It is further appreciated that the edge computing device, as used herein can refer to a cloud or non-cloud computing device that locally runs the ML model without support from a cloud processing platform. In other words, computing devices such as laptops, desktops, mobile phones, and tablet computing devices can test and/or incorporate the ML model in computing operations localized to said laptops, desktops, mobile phones, and tablet computing devices without processing support from cloud computing devices and/or non-cloud computing devices.

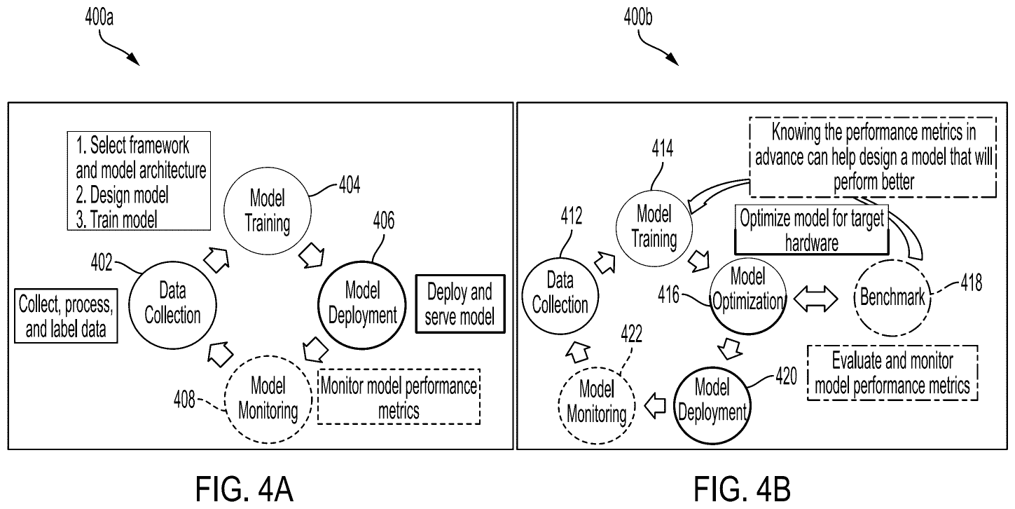

FIG. 4A shows a first exemplary ML model development and deployment life-cycle 400a. As seen in FIG. 4A, this first exemplary ML model development and deployment life-cycle can include:
1. A data collection and labeling phase 402.
2. A model training phase 404.
3. A model deployment phase 406.
4. A model monitoring phase 408.

According to one embodiment, the data collection and labeling phase 402 involves collecting data such as data (e.g., sensor data) associated with a resource site and parameterizing and/or calibrating the ML model using said data. This can involve determining or specifying a surface or subsurface parameter of interest such as: a pressure parameter associated with, underground fluid at the resource site; a temperature parameter associated with surface (e.g., surface fluid conveying mechanisms such as pipes, tanks, etc.) or subsurface structures at the resource site; a flow rate parameter of subsurface fluid at the resource site; a fluid composition parameter associated with said subsurface fluid; a particle count parameter associated with said subsurface structures at the resource site; and other parameters associated with the various data discussed in association with FIG. 2 above.

During the model training phase 404, the various real-time or near real-time data captured at the resource site referenced above, or data from sites that are similar or dissimilar relative to the above resource site may be used as training data to train the ML model. It is appreciated that the training data may also comprise synthetic data that may be dependent or independent of the real-time or near real-time data referenced herein. In particular, the various parameters of the ML model may be trained in, for example, one or more computer simulations that can involve varying various parameter data values of the ML model based on the real-time and/or near real-time, and/or based on synthetic data until convergence is achieved thereby generating a trained ML model.

During the model deployment phase 406, the trained ML model may be transmitted to, or received by, one or more edge computing devices such as those discussed in association with FIG. 1. The one or more edge computing devices may then test or use the trained ML model to generate new output data as further discussed below.

During the model monitoring phase 408, the trained ML model may be tracked or computationally observed, for example, when the model parameter values are changed or calibrated and/or when new data (e.g., new real time or new near real-time data) that is different from the training data is applied to the trained ML model to generate the new output data. If there are no deviations of the ML model performance data (e.g., model performance data/model performance metrics associated with ML model convergence) during the model monitoring phase 408, the model confidence data may be designated as being stable. However, when deviations occur away from the model performance data associated with stable operation of the trained model, the trained ML model may be downgraded or further subjected to additional training to facilitate stable model convergence or stable operation of the trained ML model on one or more edge computing devices.

FIG. 4B shows a second exemplary ML model development and deployment life-cycle 400b. As seen in FIG. 4B, this second exemplary ML model development and deployment life-cycle can include:
1. A data collection and labeling phase 412.
2. A model training phase 414.
3. A model optimization phase 416.
4. A model benchmarking phase 418.
5. A model development and deployment phase 420.
6. A model monitoring phase 422.

According to one embodiment, the data collection and labeling phase 412 is similar to the data collection phase 402 of FIG. 4A and can involve collecting data such as data (e.g., sensor data) associated with a resource site and parameterizing and/or calibrating the ML model using said data. This can involve determining or specifying surface or subsurface parameters such as those done at the data collection phase 402 of FIG. 4A.

During the model training phase 414, the various real-time or near real-time data captured at the resource site, or sites that are similar or dissimilar relative to the above resource site, or synthetic data associated with the resource site may be used as training data to train the ML model. It is appreciated that the synthetic data may be dependent or independent of the real-time or near real-time data referenced herein. It is further appreciated that the various parameters of the ML model may be trained in, for example, one or more computer simulations that can involve varying various parameter data values of the ML model based on the real-time and/or near real-time, and/or synthetic data referenced above until convergence is achieved thereby generating a trained ML model. In some cases, the computer simulations can involve complex computing operations (e.g., complex petrophysical computing operations leveraging a plurality of complex differential systems such as differential equations) that cannot be mentally performed or implemented by a person to characterize surface or subsurface data based on the trained ML model. According to one embodiment, the computer simulations involve physics-based or non-physics-based computer simulations that characterize surface or subsurface structures of a resource site during energy development.

During the model optimization phase 416, the trained ML model may be configured or calibrated, based on one or more of: hardware information associated with an edge computing device on which the trained ML model may run; software information associated with said edge computing device; firmware information associated with said edge computing device; etc. In effect, the model optimization phase 416 can involve optimizing or tweaking the trained ML model to be performant on divers similar or dissimilar edge computing devices to ensure that the deployed trained model remains convergent or performant when deployed to the divers similar or dissimilar edge computing devices.

It is appreciated that the model benchmarking phase 418 may beneficially enable leveraging performance metrics (e.g., performance data) of the trained ML model on multiple similar or dissimilar computing devices to tweak, calibrate, or configure the trained ML model on a new edge computing device that is distinct relative to the similar or dissimilar edge computing devices.

During the model deployment phase 420, the trained ML model may be transmitted to, or received by, one or more edge computing devices such as those discussed in association with FIG. 1. The one or more edge computing devices may then test or use the trained ML model to generate new output data.

During the model monitoring phase 422, the trained ML model may be tracked or computationally observed or monitored, for example, when the model parameter values are changed or calibrated or varied, and/or when new data (e.g., new real time or new near real-time data) that is different from the training data is applied to the trained ML model to generate new output data. In particular, this monitoring can occur when, for example, the trained ML model is deployed to an edge computing device and used for generating the new output data. If there are no deviations of the ML model performance data (e.g., model performance data/model performance metrics associated with ML model convergence) during the model monitoring phase 422, the model confidence data may be designated as being stable. However, when deviations occur away from the model performance data associated with stable operation of the trained model, the trained ML model may be downgraded or further subjected to additional training to facilitate stable model convergence or stable operation of the trained ML model.

A block diagram of the workflow of FIG. 4B is shown in FIG. 5 where: the data collection and model labeling step 502 corresponds to the data collection and labeling phase 412 of FIG. 4B; the model training step 504 corresponds to the model training phase 414 of FIG. 4B; the model optimization step 506 corresponds to the model optimization phase 416 of FIG. 4B; the model benchmarking step 508 corresponds to the model benchmarking phase 418 of FIG. 4B; the model deployment step 510 corresponds to the model deployment phase 420 of FIG. 4B; and the model monitoring step 512 corresponds to the model monitoring phase 422 of FIG. 4B.

As can be seen in workflow 500, the trained ML model (after blocks 502 and 504) can be optimized (block 506) for use on one or more similar or dissimilar edge computing devices based on the hardware and/or software and/or firmware of the one or more similar or dissimilar edge computing devices to which the trained ML model is deployed in order to better use the hardware capabilities of the one or more similar or dissimilar edge computing devices. In particular, data from sources such as resource sites and/or resource processing sites (e.g., hydrocarbon processing facilities) may be gathered using, for example, sensor systems as indicated at block 502. At block 504, the collected data and/or synthetic data that is computationally generated based on properties associated with the resource site may be applied to train the ML model.

Turning to block 506, the ML model may be optimized during testing to determine benchmarking data at block 508. According to some embodiments, the benchmarking data beneficially enables establishing baseline data and/or model configuration data for specific edge computing devices based on hardware and/or software comprised in the specific edge computing devices.

In addition, the ML model may be deployed for use on one or more edge computing devices at block 510. In particular, the ML model may be optionally deployed in response to being trained or automatically deployed for use on an edge computing device after the benchmarking stage of block 508. After deployment, the ML model may be monitored (e.g., at block 512) during, for example, simulations and/or tests and/or after being used to characterize, for example, surface or subsurface structures at a resource site. This monitoring may be achieved based on model performance data that is generated in response to implementing, via the simulations and/or tests involving the ML model (e.g., trained ML model), and/or after the ML model is used to characterize the surface or subsurface structures at the resource site.

According to one embodiment, performance data (e.g., performance metrics) of the optimized ML model can be determined during the model benchmarking step (block 508) to help design and/or configure and/or optimize the ML model for better performance using specific hardware data and/or specific software data and/or specific firmware data of the one or more similar or dissimilar edge computing devices and thereby facilitate model development and/or deployment (block 510) for executing the optimized ML model on the one or more similar or dissimilar edge computing devices. In some embodiments, the trained and/or optimized ML model can be further monitored while being used on the edge computing devices at block 512 to further determine its performance. In some implementations, the benchmarking computing operations beneficially assist quick decision making on computing framework selection (e.g., hardware, software, or firmware of an edge computing device) and/or ML model selection for use on the one or more similar or dissimilar edge computing device as well as expediting edge artificial intelligence (AI) method and system development/deployment lifecycle of the ML model under consideration.

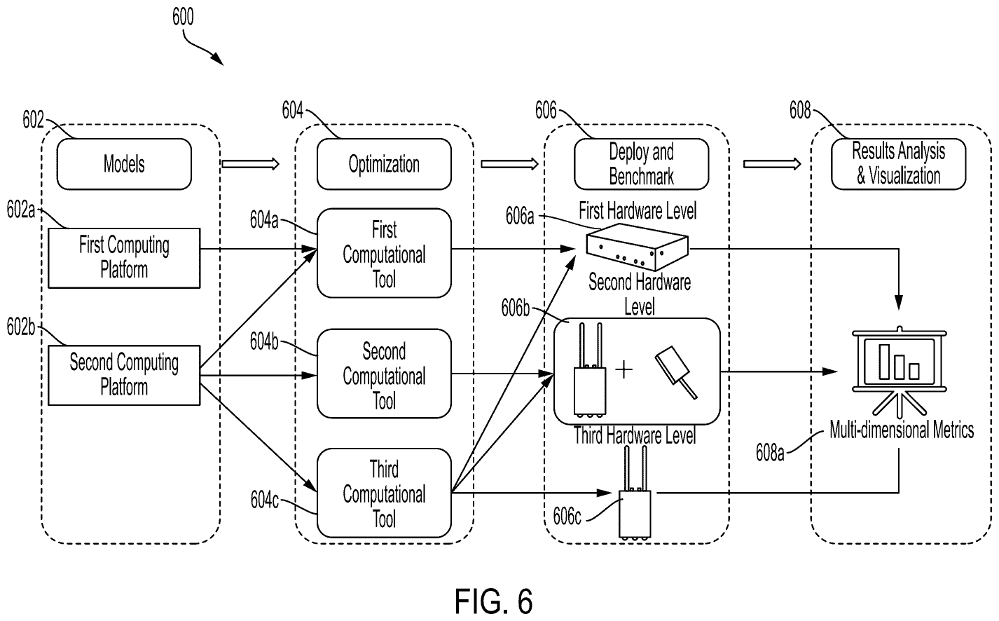

FIG. 6 indicates an exemplary workflow 600 for deploying an ML model to one or more similar or dissimilar edge computing devices. As shown in the figure, ML model(s) 602 may be associated with specific computing platforms and/or specific fundamental structures/systems 602a and 602b. In one embodiment, the specific computing platforms and/or specific fundamental structures/systems 602a and 602b may comprise specific functional, logical, or object-oriented computing systems associated with a programming language used to develop the ML model(s) 602. The specific computing platforms and/or specific fundamental structures/systems 602a and 602b may also comprise specific applications used to develop the ML model(s) 602. According to one embodiment, the specific computing platforms and/or specific fundamental structures/systems 602a and 602b may comprise specific data structures used to generate the ML model(s) 602.

According to one embodiment, the ML model(s) 602 is optimized at block 604 for use on one or more similar or dissimilar edge computing devices. To achieve this, each of the specific computing platforms and/or specific fundamental structures/systems 602a and 602b may have attendant computational tools 604a . . . 604c that enable dynamically (e.g., real time or near-real time) tuning, customizing, configuring or optimizing the ML model(s) 602 at the optimization stage for deployment or use on a specific edge computing device. According to one embodiment, the dynamic tuning, customizing, configuring, or optimizing of the ML model(s) can be based on one or more of: hardware specification data of each of the one or more similar or dissimilar edge computing devices; software specification data of each of the one or more similar or dissimilar edge computing devices; and firmware specification data of each of the one or more similar or dissimilar edge computing devices.

To reiterate, the computational tools 604a . . . 604c can include one or more computing services adapted to dynamically quantize, configure, tweak, or tune a given ML model based on the hardware, software, or firmware specification data associated with the one or more similar or dissimilar edge computing devices to which the ML model is subsequently deployed. Furthermore, because the gateway systems referenced herein can have a plurality of tiers (e.g., a hardware tier, a firmware tier, a software tier, etc.), the computational tools 604a . . . 604c can be modified to configure, tune, or quantize the ML model(s) based on one or more corresponding tiers (e.g., hardware tier, firmware tier, software tier) to which the one or more similar or dissimilar edge computing devices belong.

According to some embodiments, the gateway systems referenced herein can be used to build edge artificial intelligence (AI) systems such as ML models depending on use cases (e.g., a first domain model use case, a second domain model use case, etc.) associated with said ML models. The use cases, for example, may comprise specific energy development domains including: an upstream energy development domain related to exploring and/or developing energy; a midstream energy development domain associated with conveying or transporting and storing energy; and a downstream energy development domain related to refining and/or distributing refined or unrefined energy.

In some cases, the ML model(s) disclosed may be optimized (e.g., enhanced, tweaked, configured, or parameterized) at the optimization block 604 using data associated with graphics processing units (GPUS) (e.g., Nvidia GPUs, Nvidia TensorRT) and/or hardware accelerator data (e.g., Google Coral Edge TPU accelerator data) associated with the edge computing devices to which the ML model(s) are deployed after optimization.

According to one embodiment, inefficient manual processes that not only delay development, deployment, and optimizing the disclosed ML models but are also infeasible for designing, calibrating, testing, and deploying the disclosed ML models to an edge computing device may be reduced or eliminated by using the gateway systems to provide consistent and reliable benchmarks used to track or otherwise stabilize (e.g., achieve model convergence) the disclosed ML model(s) during the deployment or benchmarking stage 606. At the benchmarking stage 606, inference data may be generated and applied to testing the performance of the deployed ML models on the one or more similar or dissimilar edge computing devices such that performance data generated by using or implementing the ML model(s) on the one or more similar or dissimilar edge computing devices can be compared or correlated against expected data values for computing operations implemented using the configured or deployed ML model(s) on the one or more similar or dissimilar edge computing devices. In some cases, the benchmarking stage comprises an automated benchmarking process that leverages computing services including model version computing services, model reporting computing services, and model management and updates computing services.

According to one embodiment, one or more inference computing environments may be automatically configured or set up for the ML model(s) during the deployment and benchmarking or testing stage 606 by using docker images for the different hardware/firmware/software capabilities 606a . . . 606c of the one or more similar or dissimilar edge computing devices so as to account for the different tiers and/or different deep learning frameworks to which the ML model(s) belong. The deployment and benchmarking stage 606 can be extended to evaluate new ML model(s) relative to tier data (e.g., hardware data of an edge computing device, firmware data of the edge computing device, software data of the edge computing device, etc.) associated with the one or more similar or dissimilar edge computing devices under consideration.

Results 608 from the deployment and benchmarking stage 606 may be visualized on a graphical interface to assess performance data of the ML model(s) under consideration. The results 608, for example, may be dynamically formatted and/or calibrated for visualization on a display device of an edge or non-edge computing device as the case may require. In some cases, the results 608 comprise a multi-dimensional graph, image, or video performance data associated with the deployed and benchmarked ML model(s). The results 608 can also include textual data that provide context or clarify various aspects or dimensions of the results 608. It is appreciated that the results 608 can be looped back/feedbacked or used to inform the optimization process at the optimization stage 604 and thereby beneficially refine the ML model(s) as needed.

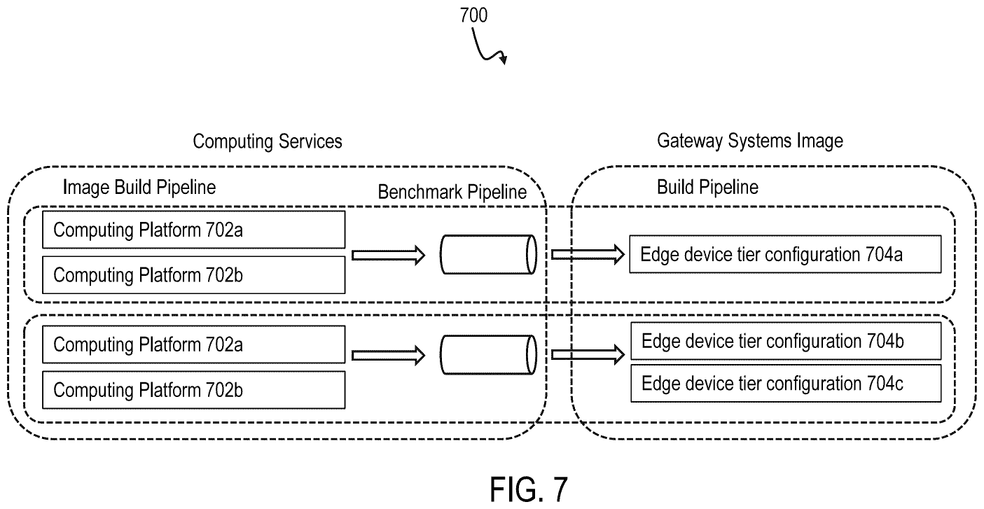

FIG. 7 shows an interaction 700 between computing services and gateway systems during model deployment and benchmarking. As seen in the figure, computing platforms 702a and 702b may be applied, based on tier data associated with one or more edge computing devices to configure one or more ML models for deployment on said one or more edge computing devices and thereby generate model configuration data 704a . . . 704c used to quantize or otherwise configure, tune, or finetune the ML models for deployment and usage on edge computing devices. It is appreciated that the above deployment and benchmarking computing process flexibly accounts for a plurality of ML models including domain-specific models (e.g., energy development domain models). It is further appreciated that the disclosed model deployment and benchmarking computing process advantageously automates and/or replicates model benchmarking and/or model deployment to a plurality of edge computing devices regardless of the tier to which said edge computing devices belong.

### Detailed Workflow

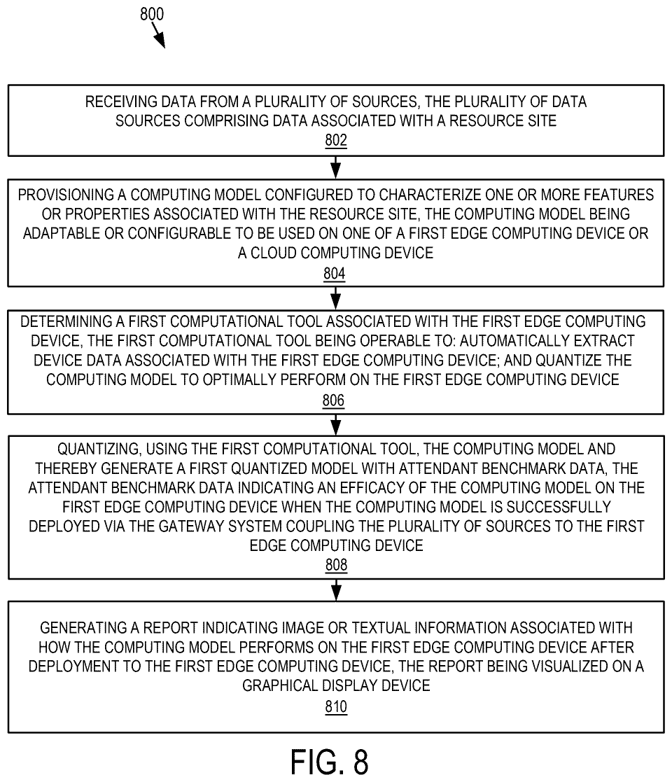

FIG. 8 shows an exemplary benchmarking workflow 800 for enabling communication between data sources and an edge computing device via a gateway system. It is appreciated that a data engine stored in a memory device may cause a computer processor to execute one or more processing stages of the workflow 800. For example, the disclosed techniques may be implemented as a data engine of a computing platform associated with a geological software tool such that the data engine enables optimally modeling features associated with a resource site using an ML model, configuring the ML model for optimal performance on an edge computing device, and deploying the configured ML model for use on the edge computing device.

At block 802, the data engine receives data from a plurality of sources (e.g., data sources). The plurality of data sources (e.g., such as those discussed in association with FIG. 1) can comprise data associated with a resource site.

Turning to block 804, the data engine provisions a computing model configured to characterize one or more features or properties associated with the resource site. The computing model can be adaptable, configurable, or tunable to be used on one of a first edge computing device or a cloud computing device.

The data engine may be used at block 806 to determine a first computational tool associated with the first edge computing device. The first computational tool may be operable to: automatically extract device data associated with the first edge computing device; and quantize or configure the computing model to optimally perform on the first edge computing device based on the extracted device data.

Turning to block 808, the data engine quantizes, tunes, or configures, using the first computational tool, the computing model thereby generating a first quantized model with attendant benchmark data. It is appreciated that the attendant benchmark data indicates an efficacy of the computing model on the first edge computing device when the computing model is successfully deployed via the gateway system coupling (e.g., communicatively coupling or connecting) the plurality of sources to the first edge computing device.

In addition, the data engine can generate a report indicating image or textual information associated with how the computing model performs on the first edge computing device after deployment to the first edge computing device. This report may be visualized on a graphical display device such as a display screen of laptop, a desktop, a tablet computing device, mobile computing device, a phablet, etc.

These and other implementations may each optionally include one or more of the following features.

The computing model is a computer vision model according to some embodiments.

The device data can comprise one or more of: hardware data of the first edge computing device; software data of the first edge computing device; or firmware data of the first edge computing device.

Furthermore, the hardware data can comprise one of: graphical display unit data associated with the first edge computing device; or central processing unit data associated with the first edge computing device.

According to one embodiment, quantizing or tuning or configuring the computing model comprises stripping or trimming parameters of the computing model that contribute to model inefficiencies of the computing model on the first edge computing device.

In some cases, quantizing the computing model comprises optimizing (e.g., configuring) the computing model to be compatible with one or more hardware accelerators of the first edge computing device.

Furthermore, quantizing the computing model can comprise: determining a computation float point for the computing model based on the extracted device data; and automatically configuring the computing model to quickly execute computing operations associated with the resource site on the first edge computing device.

In one embodiment, the first computational tool comprises one of an application programming interface (API) or a compiler.

In other embodiments, the first computational tool comprises a computing platform configured for developing deep learning models.

In some cases, the computing model comprises a machine learning model or an artificial intelligence model.

In addition, the gateway system comprises an Agora gateway system according to some embodiments.

Moreover, the gateway system may be configured or coupled to sensor systems associated with collecting data at the resource site.

It is appreciated that the resource site comprises a resource site associated with energy development.

It is further appreciated that the attendant benchmark data indicates performance data (e.g., baseline performance data) associated with implementing the computing model on the cloud computing device.

According to one embodiment, the data engine may be used to further: determine a second computational tool associated with a second edge computing device; quantize, using the second computational tool, the computing model and thereby generate a second quantized model; and deploy the second quantized model via the gateway system to the second edge computing device. It is appreciated that the second edge computing device may be operable to rapidly execute a plurality of computing operations associated with the resource site using the second quantized model.

In some cases, the first edge computing device and the second edge computing device are distinct from each other based on at least one of: first hardware of the first edge computing device being different from second hardware of the second edge computing device; first firmware of the first edge computing device being different from second firmware of the second edge computing device; or first software of the first edge computing device being different from second software of the second edge computing device.

While any discussion of or citation to related art in this disclosure may or may not include some prior art references, there is no concession or acquiescence to the position that any given reference is prior art or analogous prior art.

The foregoing description, for purpose of explanation, has been described with reference to specific embodiments. However, the illustrative discussions above are not intended to be exhaustive or to limit this solution to the precise forms disclosed. Many modifications and variations are possible in view of the above teachings. The embodiments were chosen and described in order to explain the principles of the disclosed technology and its practical applications, to thereby enable others skilled in the art to use the disclosed subject matter and various embodiments with various modifications as are suited to the particular use contemplated.

It will also be understood that, although the terms first or second may be used herein to describe various elements, these elements should not be limited by these terms. These terms are used to distinguish one element from another. For example, a first object or step could be termed a second object or step, and, similarly, a second object or step could be termed a first object or step, without departing from the scope of this disclosure. The first object or step, and the second object or step, are both objects or steps, respectively, but they are not to be considered the same object or step.

The terminology used in the description herein is for the purpose of describing particular embodiments and is not intended to be limiting. As used in the description of this disclosure and the appended claims, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Those with skill in the art will appreciate that while some terms in this disclosure may refer to absolutes, the methods and techniques disclosed herein may also be performed on fewer than all of a given thing, e.g., performed on one or more components and/or performed by one or more computing device processors or one or more data processing engines. Accordingly, in instances in the disclosure where an absolute is used, the disclosure may also be interpreted to be referring to a subset.

What is claimed is:

1. A benchmarking method for enabling communication between data sources and an edge computing device via a gateway system, the method comprising:
receiving data from a plurality of sources, the plurality of data sources comprising data associated with a resource site;
provisioning a computing model configured to characterize one or more features or properties associated with the resource site, the computing model being adaptable or configurable to be used on one of a first edge computing device or a cloud computing device;
determining a first computational tool associated with the first edge computing device, the first computational tool being operable to:
automatically extract device data associated with the first edge computing device, and
quantize the computing model to optimally perform on the first edge computing device;
quantizing, using the first computational tool, the computing model and thereby generate a first quantized model with attendant benchmark data that indicates an efficacy of the computing model on the first edge computing device when the computing model is successfully deployed via the gateway system coupling the plurality of sources to the first edge computing device; and
generating a report indicating image or textual information associated with how the computing model performs on the first edge computing device after deployment to the first edge computing device, the report being visualized on a graphical display device.

2. The method of claim 1, wherein the computing model is a computer vision model.

3. The method of claim 1, wherein the device data comprises one or more of:
hardware data of the first edge computing device;
software data of the first edge computing device; or
firmware data of the first edge computing device.

4. The method of claim 3, wherein the hardware data comprises one of:
graphical display unit data associated with the first edge computing device; or
central processing unit data associated with the first edge computing device.

5. The method of claim 1, wherein quantizing the computing model comprises stripping or trimming parameters of the computing model that contribute to model inefficiencies of the computing model on the first edge computing device.

6. The method of claim 1, wherein quantizing the computing model comprises optimizing the computing model to be compatible with one or more hardware accelerators of the first edge computing device.

7. The method of claim 1, wherein quantizing the computing model comprises:
determining a computation float point for the computing model based on the extracted device data; and
automatically configuring the computing model to quickly execute computing operations associated with the resource site on the first edge computing device.

8. The method of claim 1, wherein the first computational tool comprises one of an application programming interface (API) or a compiler.

9. The method of claim 1, wherein the first computational tool comprises a computing platform configured for developing deep learning models.

10. The method of claim 1, wherein the computing model comprises a machine learning model or an artificial intelligence model.

11. The method of claim 1, wherein the gateway system comprises an Agora gateway system.

12. The method of claim 1, wherein the gateway system is configured or coupled to sensor systems associated with collecting data at the resource site.

13. The method of claim 1, wherein the resource site comprises a resource site associated with energy development.

14. The method of claim 1, wherein the attendant benchmark data indicates baseline performance data associated with implementing the computing model on the cloud computing device.

15. The method of claim 1, further comprising:
determining a second computational tool associated with a second edge computing device;
quantizing, using the second computational tool, the computing model and thereby generate a second quantized model; and
deploying the second quantized model via the gateway system to the second edge computing device, the second edge computing device being operable to rapidly execute a plurality of computing operations associated with the resource site using the second quantized model.

16. The method of claim 15, wherein the first edge computing device and the second edge computing device are distinct from each other based on at least one of:
first hardware of the first edge computing device being different from second hardware of the second edge computing device;
first firmware of the first edge computing device being different from second firmware of the second edge computing device; or
first software of the first edge computing device being different from second software of the second edge computing device.

17. A system for enabling communication between data sources and an edge computing device via a gateway system, the system comprising:
a computer processor, and
memory storing instructions that are executable by the computer processor to:
receive data from a plurality of sources, the plurality of data sources comprising data associated with a resource site;
provision a computing model configured to characterize one or more features or properties associated with the resource site, the computing model being adaptable or configurable to be used on one of a first edge computing device or a cloud computing device;
determine a first computational tool associated with the first edge computing device, the first computational tool being operable to:
automatically extract device data associated with the first edge computing device, and
quantize the computing model to optimally perform on the first edge computing device;
quantize, using the first computational tool, the computing model and thereby generate a first quantized model with attendant benchmark data, the attendant benchmark data indicating an efficacy of the computing model on the first edge computing device when the computing model is successfully deployed via the gateway system coupling the plurality of sources to the first edge computing device; and
generate a report indicating image or textual information associated with how the computing model performs on the first edge computing device after deployment to the first edge computing device, the report being visualized on a graphical display device.

18. The system of claim 17, wherein the device data comprises one or more of hardware data, software data, or firmware data, such that the hardware data comprises one of:
graphical display unit data associated with the first edge computing device; or
central processing unit data associated with the first edge computing device.

19. The system of claim 17, wherein quantizing the computing model comprises stripping or trimming parameters of the computing model that contribute to model inefficiencies of the computing model on the first edge computing device.

20. The system of claim 17, wherein quantizing the computing model comprises optimizing the computing model to be compatible with one or more hardware accelerators of the first edge computing device.
